(19) United States
(12) Patent Application Publication
(10) Pub. No.: US 2006/0101135 A1
(43) Pub. Date: May 11, 2006

(54) Network modeling systems and methods

(76) Inventor: Jiang Li, Plano, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/973,029

(22) Filed: Oct. 25, 2004

(51) Int. Cl. G06F 15/173

(52) U.S. Cl. 709/223

(57) ABSTRACT

Embodiments of network modeling systems and methods are disclosed. In one method embodiment, the network modeling method includes receiving multiple 4-port s-parameter measurements corresponding to an 8-port device and generating an 8-port model from the multiple 4-port s-parameter measurements.

### BACKGROUND

Network modeling is a technique often used to represent physical components, signal paths, and/or systems in general. For instance, designers of proposed network topologies, such as for a semiconductor circuit design, often use one or more models to characterize signal paths. The model can then be used in simulations, using various design software such as SPICE, which provides for observation of performance and enables designers and other persons to make decisions on component and/or system design choice. One approach that may be used to model a signal path includes building the actual hardware and testing it. However, an often less expensive approach is to build a model out of various components of the proposed network topology, and simulate outputs under various input scenarios. This may also be the only feasible approach when system hardware is not available for testing.

For networks such as high-speed digital links, current models may pose limitations. For example, RLC (resistor-inductor-capacitor) models are typically implemented by a user inputting a signal path structure using a limited data format. Further, the assumptions and/or simplifications of RLC models as well as the analysis engine/methodology often limit accuracy. The fact that RLC models are static tools also limits their effectiveness at high data rates.

Measurement-based models may provide an improvement over RLC models. For example, a device under test (DUT) may be configured with various components that provide a variety of signal paths (thus providing a multitude of measurable signal performance characteristics). High data rates can typically be accommodated in measurement-based models. However, measurement-based models may be limited by the equipment available, among other limitations. For instance, measurement equipment currently available generally includes one single-ended signal path (e.g., 2-port) or one differential signal path (e.g., 4-port). With limited port availability, measurement-based models may fail to include some information that is important to network design, such as cross-talk information, or may be hindered for networks that are represented using more than the amount of ports available on the measurement equipment.

### SUMMARY

An embodiment of a network modeling method comprises receiving six 4-port s-parameter measurements corresponding to an 8-port device; saving the six 4-port s-parameter measurements in a plurality of data files; and combining the plurality of data files into a model data file, the model data file representing the 8-port device.

An embodiment of a network modeling system comprises a memory with modeling software; and a processor configured with the modeling software to receive multiple 4-port s-parameter measurements corresponding to an 8-port device, save the multiple 4-port s-parameter measurements in a plurality of data files, and combine the plurality of data files into a model data file, the model data file representing the 8-port device.

An embodiment of a network modeling system comprises means for receiving six 4-port s-parameter measurements corresponding to an 8-port device; means for saving the six 4-port s-parameter measurements in a plurality of data files; and means for combining the plurality of data files into a model data file, the model data file representing the 8-port device.

An embodiment of a computer program for modeling a network, the program being stored on a computer-readable medium, comprises logic configured to receive multiple 4-port s-parameter measurements corresponding to an 8-port device; logic configured to save the multiple 4-port s-parameter measurements in a plurality of data files; and logic configured to combine the plurality of data files into a model data file, the model data file representing the 8-port device.

An embodiment of a network modeling method comprises generating a plurality of 8-port models, each of the plurality of 8-port models corresponding to a victim pair and a culprit pair for a multi-port device, the multi-port device having N ports; and combining the plurality of 8-port models to generate an N-port model.

An embodiment of a network modeling system comprises a memory with modeling software; and a processor configured with the modeling software to generate a plurality of 8-port models, each of the plurality of 8-port models corresponding to a victim pair and a culprit pair for an N-port device, wherein the processor is configured with the modeling software to combine the plurality of 8-port models to generate an N-port model.

An embodiment of a network modeling system comprises means for generating a plurality of 8-port models, each of the plurality of 8-port models corresponding to a victim pair and a culprit pair for a multi-port device, the multi-port device having N ports; and means for combining the plurality of 8-port models to generate an N-port model.

An embodiment of a computer program for modeling a network, the program being stored on a computer-readable medium, comprises logic configured to generate a plurality of 8-port models, each of the plurality of 8-port models corresponding to a victim pair and a culprit pair for a multi-port device, the multi-port device having N ports; and logic configured to combine the plurality of 8-port models to generate an N-port model.

An embodiment of a network modeling method comprises receiving multiple 4-port s-parameter measurements corresponding to an 8-port device; and generating an 8-port model from the multiple 4-port s-parameter measurements.

### BRIEF DESCRIPTION OF THE DRAWINGS

The components in the drawings are not necessarily to scale, emphasis instead being placed upon clearly illustrating the principles of the disclosed systems and methods. Moreover, in the drawings, like reference numerals designate corresponding parts throughout the several views.

FIG. 1A is a block diagram that illustrates an embodiment of a network modeling system.

FIG. 1B is a block diagram that illustrates an embodiment of a computer configured with modeling software as shown in FIG. 1A.

FIG. 2 is a flow diagram of a method embodiment of the modeling software shown in FIG. 1B, the method providing for modeling or representing an 8-port network using six 4-port s-parameter measurements.

FIGS. 3A-3F are schematic diagrams of exemplary port configurations used to obtain s-parameter measurements that fully characterize an 8-port network using the modeling method shown in FIG. 2.

FIGS. 4A-4F are schematic diagrams that illustrate matrix processing as implemented by the method shown in FIG. 2, the matrices generated based on the port configurations shown in FIGS. 3A-3F.

FIG. 5 is a flow diagram of a method embodiment of the modeling software shown in FIG. 1B, the method providing for modeling cross-talk for multi-port networks.

FIG. 6 is a schematic diagram that illustrates a 12-port device under test (DUT) with a victim pair and two culprit pairs.

FIGS. 7A-C are schematic diagrams that illustrate matrix processing as implemented by the method shown in FIG. 5, the matrices generated based on 8-port network modeling shown in FIGS. 1A-4F.

FIG. 8 is a schematic diagram that illustrates a 16-port DUT with a victim pair and three culprit pairs.

FIGS. 9A-9D are schematic diagrams that illustrate matrix processing as implemented by the method shown in FIG. 5, the matrices generated based on 8-port network modeling shown in FIGS. 1A-4F.

### DETAILED DESCRIPTION

Disclosed are various embodiments of network modeling systems and methods (herein referred to as a network modeling system for brevity). In one embodiment, a network modeling system includes functionality to characterize the behavior of (i.e., to model or represent) an 8-port network using six, 4-port s-parameter analyzer measurements. The resulting network model can be used in simulations to characterize the electrical performance of high-speed links, with bandwidths generally ranging from DC to 20 giga-Hertz (GHz). A network modeling system also includes functionality to characterize multi-port networks beyond an 8-port network (e.g., 12-ports, 16-ports, etc.), providing a frequency domain differential cross-talk model for high-speed links.

S-parameters (or scattering parameters) generally refer to reflection and transmission coefficients between incident and reflection signals, and can be used to describe the behavior of a device. Also, a link generally refers to a communication medium between components, such as a signal path between two ASICs (application specific integrated circuits).

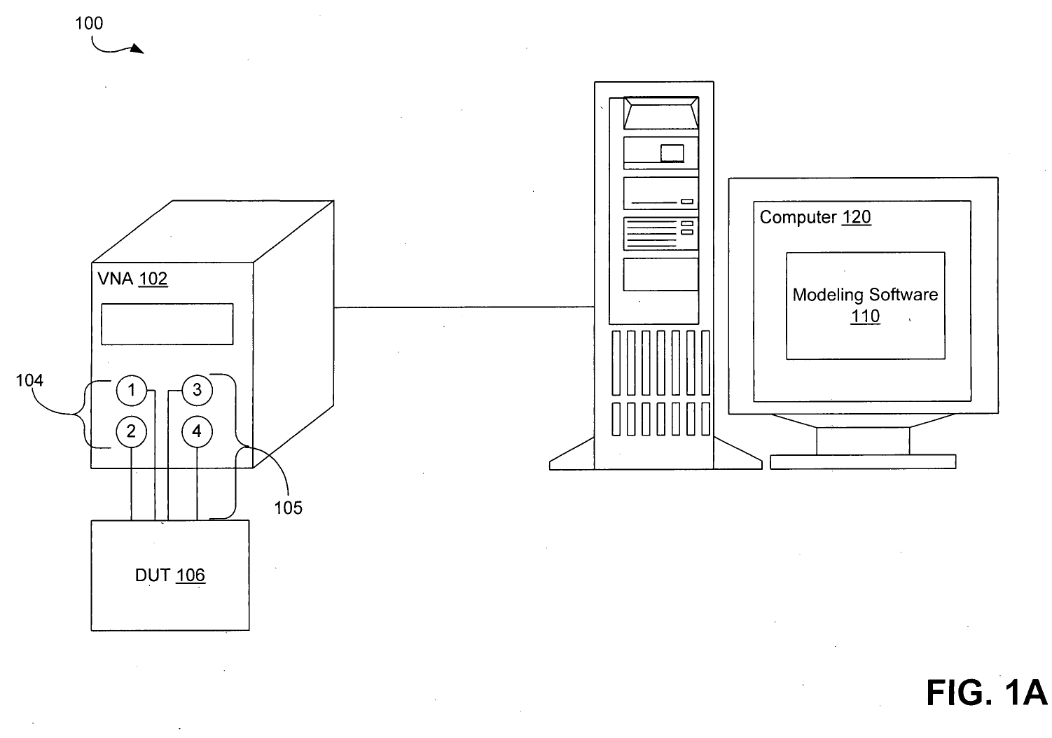

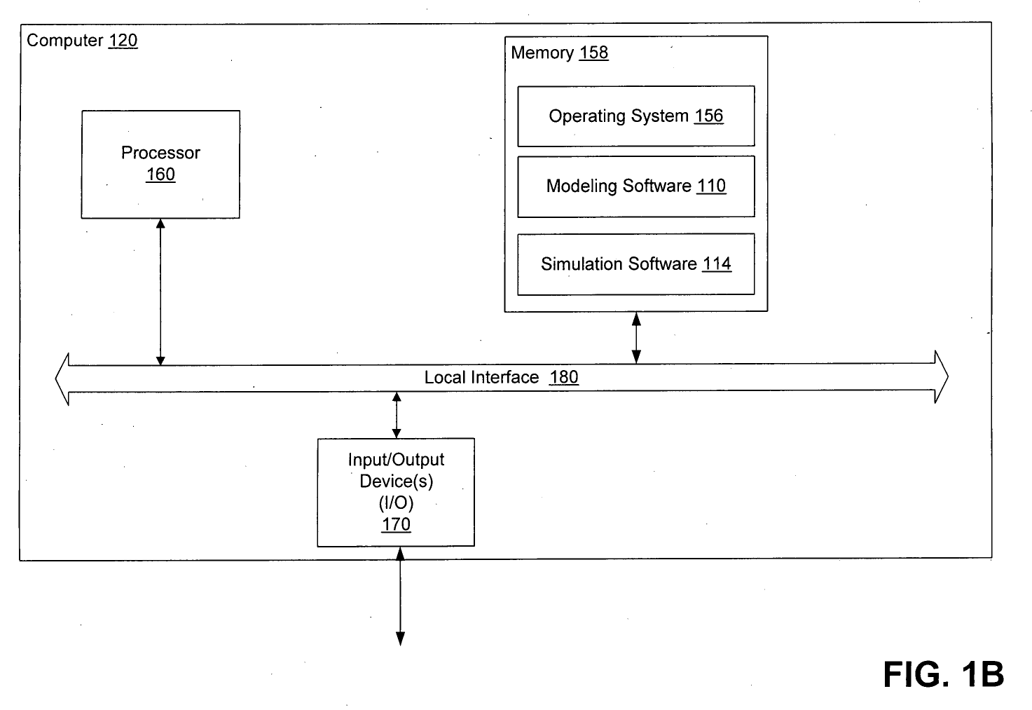

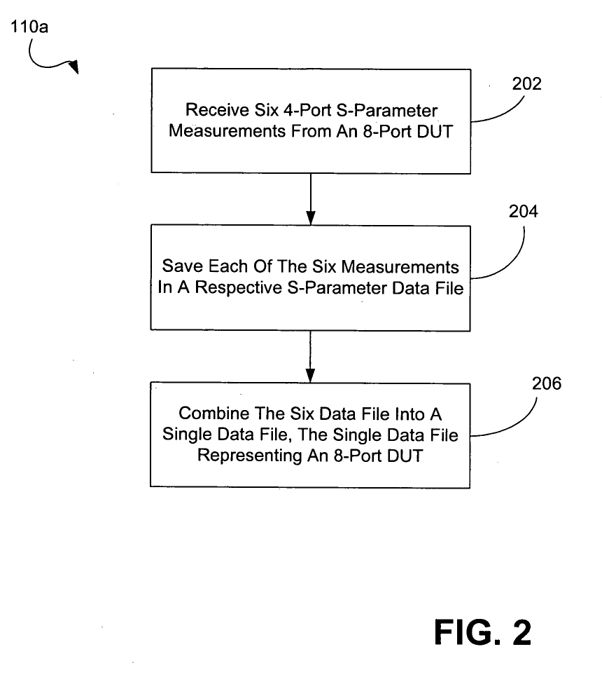

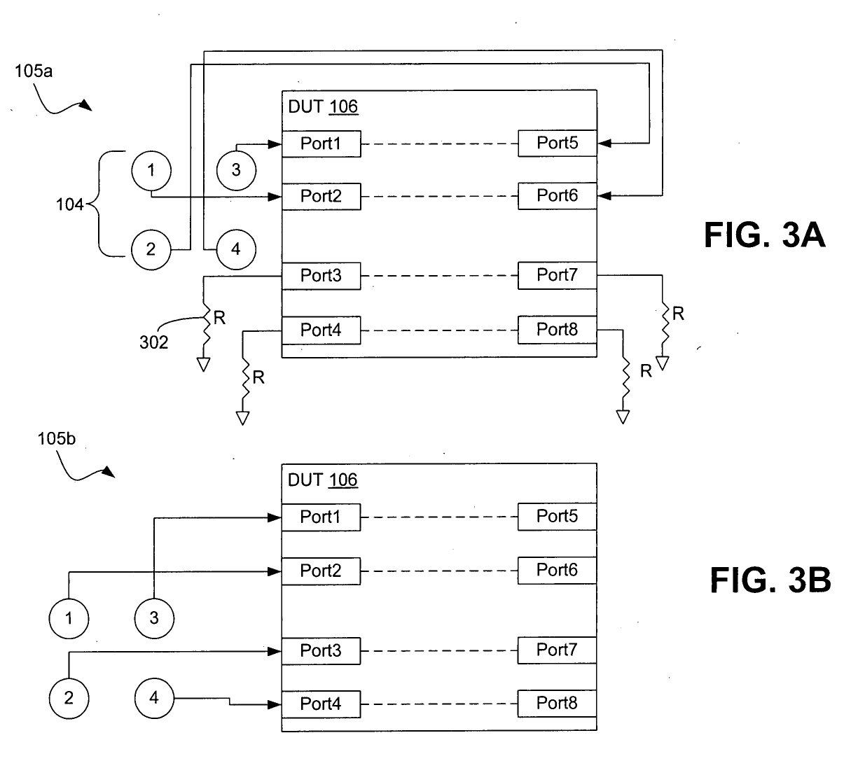

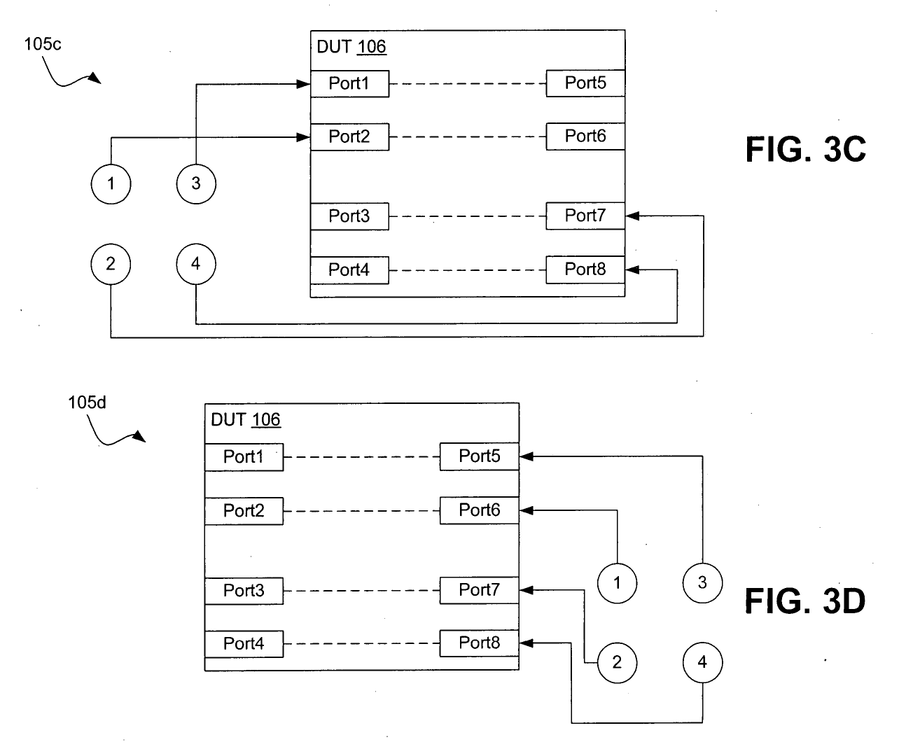

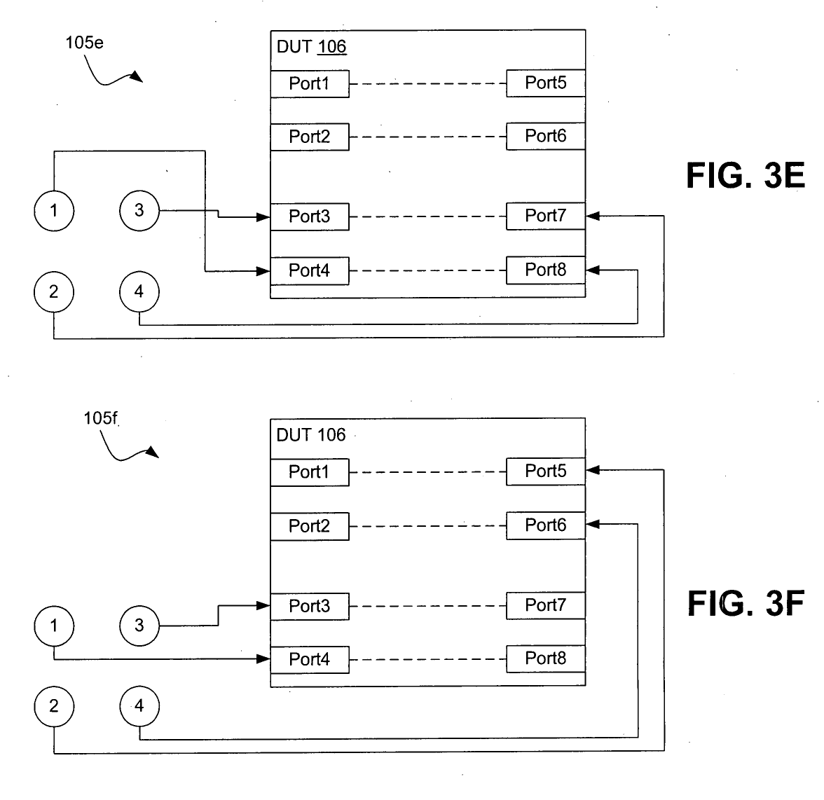

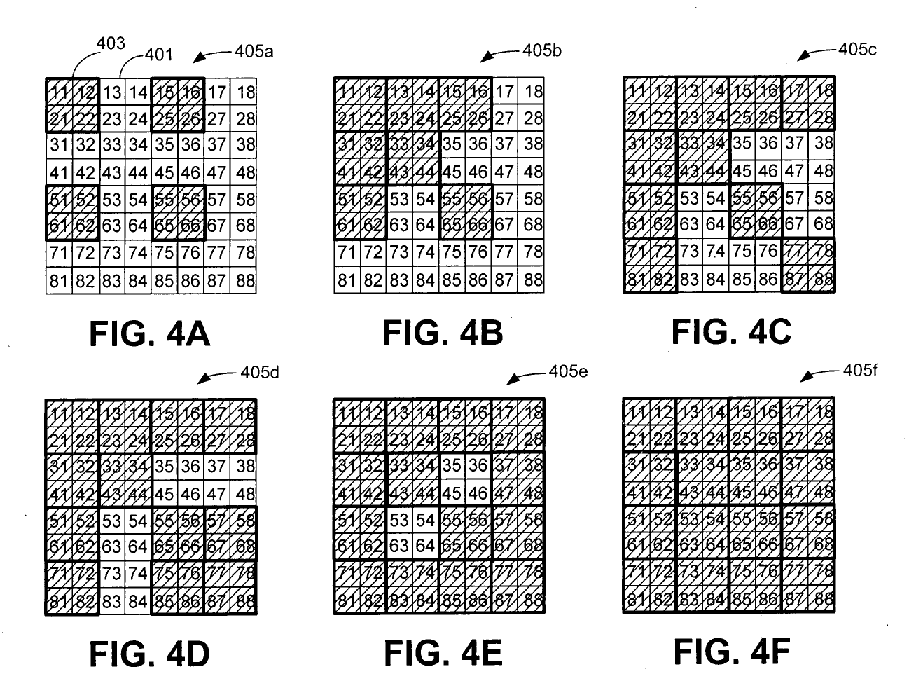

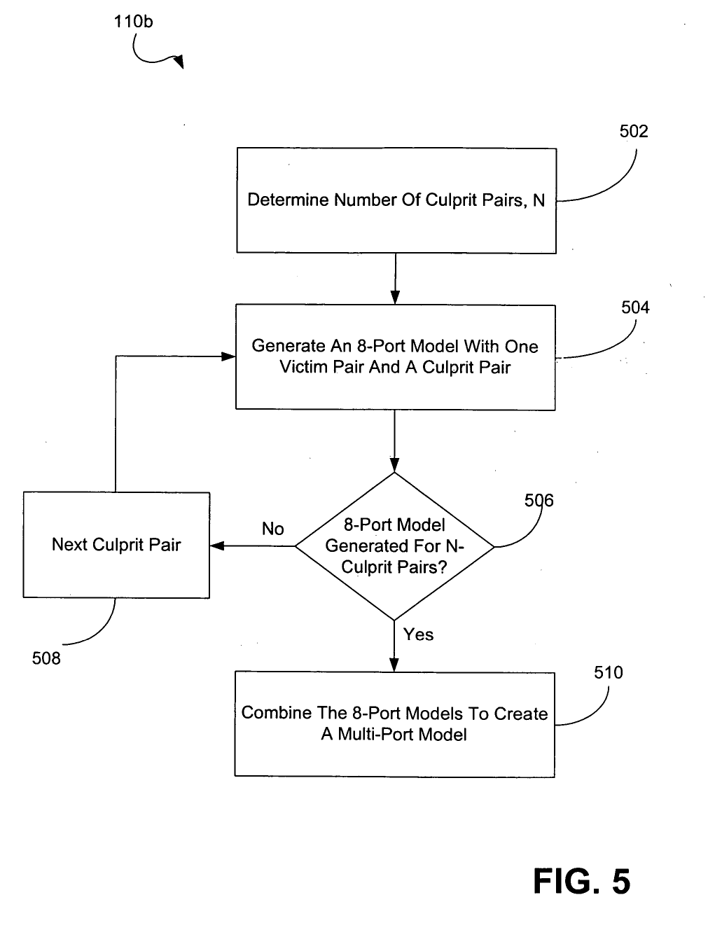

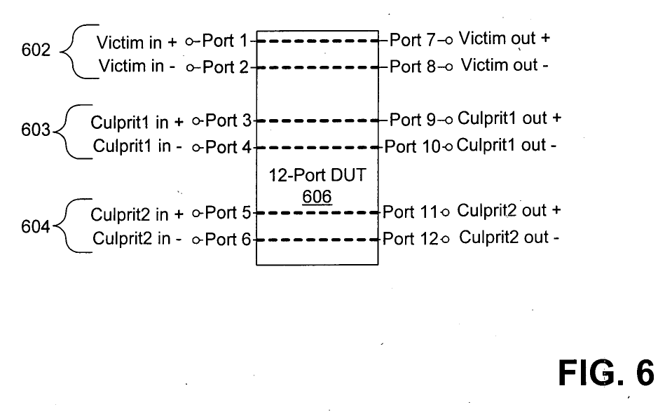

An embodiment of a network modeling system is illustrated in FIG. 1A, which includes a computer configured with modeling software in communication with a network analyzer that acquires s-parameter measurements from a device under test (DUT). FIG. 1B illustrates a computer architecture embodiment, and FIG. 2 shows a method embodiment of the modeling software. FIGS. 3A-3F illustrate various port configurations used to take s-parameter measurements from a DUT configured with 8-ports. FIGS. 4A-4F illustrate matrix processing implemented by the modeling software to fully characterize the 8-port DUT. FIG. 5 illustrates a modeling method embodiment that characterizes coupling (e.g., cross-talk) in multi-port networks, and FIGS. 6-9D provide 12-port and 16-port coupling illustrations and matrix processing for the same. It will be understood that the principles disclosed herein can be applied to multi-port devices and networks in addition to the disclosed examples.

FIG. 1A is a block diagram that illustrates an embodiment of a network modeling system 100. The network modeling system 100 includes an exemplary vector network analyzer (VNA) 102, a device under test (DUT) 106, and a computer 120. The VNA 102 includes four front panel ports 104 (labeled 1-4). The VNA 102 takes s-parameter measurements of the DUT 106 using a plurality of connection configurations 105, as described below. The VNA 102 may display the s-parameter measurements in a curve or format the same in one or more data files. The DUT 106 may represent one or more devices, the signal paths between and/or including the devices, or a network. Although shown with four connections, the DUT 106 can have a different quantity of connections. The computer 120 includes modeling software 110. The modeling software 110 receives the s-parameter measurements from the VNA 102 and generates a multi-port network model. Although shown using a vector network analyzer 102, other measurement/diagnostic equipment may be used.

FIG. 1B is a block diagram that illustrates an embodiment of the computer 120. The computer 120 includes the modeling software 110 that receives s-parameterization measurements and configures measurements into an 8-port network model. The modeling software 110, or like-functionality, can be implemented in whole or in part in the computer 120, or in some embodiments, in other devices such as the VNA 102. The computer 120 may include fewer or additional components. Generally, in terms of hardware architecture, the computer 120 includes a processor 160, memory 158, and one or more input and/or output (I/O) devices 170 that are communicatively coupled via a local interface 180. The local interface 180 can be, for example but not limited to, one or more buses or other wired or wireless connections. The local interface 180 may have additional elements, which are omitted for simplicity, such as controllers, buffers (caches), drivers, repeaters, and receivers, to enable communications. Further, the local interface 180 may include address, control, and/or data connections to enable appropriate communications among the aforementioned components.

The processor 160 is a hardware device for executing software, particularly that which is stored in memory 158. The processor 160 can be any custom made or commercially available processor, a central processing unit (CPU), an auxiliary processor among several processors associated with the computer 120, a semiconductor-based microprocessor (in the form of a microchip or chip set), a macroprocessor, or generally any device for executing software instructions.

Memory 158 can include any one or combination of volatile memory elements (e.g., random access memory (RAM, such as DRAM, SRAM, SDRAM, etc.)) and nonvolatile memory elements (e.g., read-only memory (ROM)). Memory 158 cooperates through the local interface 180. In some embodiments, memory 158 may incorporate electronic, magnetic, optical, and/or other types of storage media. Note that memory 158 can have a distributed architecture, where various components are situated remote from one another, but can be accessed by the processor 160.

The software in memory 158 may include one or more separate programs, each of which comprises an ordered listing of executable instructions for implementing logical functions. In the example of FIG. 1B, the software in memory 158 includes a suitable operating system (O/S) 156, the modeling software 110, and simulation software 114 (e.g., SPICE). In general, the operating system 156 essentially controls the execution of other computer programs, and provides scheduling, input-output control, file and data management, memory management, and communication control and related services.

The modeling software 110 is a source program, executable program (object code), script, or any other entity comprising a set of instructions to be performed. The modeling software 110 can be implemented as a single module or as a distributed network of modules of like-functionality. When the modeling software 110 is a source program, then the program is translated via a compiler, assembler, interpreter, or the like, which may or may not be included within the memory 158, so as to operate properly in connection with the O/S 156.

The I/O devices 170 may include input devices, for example but not limited to, a keyboard, mouse, scanner, microphone, etc. Furthermore, the I/O devices 170 may also include output devices, for example but not limited to, a printer, display, etc. Finally, the I/O devices 170 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

When the computer 120 is in operation, the processor 160 is configured to execute software stored within the memory 158, to communicate data to and from the memory 158, and to generally control operations of the computer 120 pursuant to the software. For example, the modeling software 110, in whole or in part, is read by the processor 160, perhaps buffered within the processor 160, and then executed.

When the modeling software 110 is implemented in software, as is shown in FIG. 1B, it should be noted that the modeling software 110 can be stored on any computer-readable medium for use by or in connection with any computer related system or method. In the context of this document, a computer-readable medium is an electronic, magnetic, optical, or other physical device or means that can contain or store a computer program for use by or in connection with a computer related system or method. The modeling software 110 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. The computer-readable medium may be portable.

Any process descriptions or blocks in flow diagrams used herein should be understood as representing modules, segments, or portions of code which include one or more executable instructions for implementing specific logical functions or steps in the process, and alternate implementations are included within the scope of the disclosure in which functions may be executed out of order from that shown or discussed, including substantially concurrently or in reverse order, depending on the functionality involved.

With continued reference to FIGS. 1A-1B, FIG. 2 is a flow diagram of a method embodiment 110a for the modeling software 110 shown in FIG. 1B. The modeling method 110a provides an 8-port network model from six 4-port device s-parameter measurements. The VNA 102 takes six 4-port s-parameter measurements from the DUT 106 and forwards the same to the modeling software 110 (202). The modeling software 110 saves each of the six s-parameter measurements in six individual s-parameter data files (204). The modeling software 110 combines the six individual files into one data file (206). The data file may be formatted for use by the simulation software 114. In one embodiment, the individual data files include a 4×4 matrix of s-parameter data that are executed in a postscript process to generate the single data file. The single data file may include an 8×8 matrix of the measured s-parameters. Other mechanisms to combine the data files may be implemented. The single data file represents or characterizes the 8-port DUT 106. The 8-port DUT model (e.g., network model) is then used by the simulation software 114 to provide performance characteristics for a particular network based on a plurality of different inputs, signal paths, and/or components.

FIGS. 3A-3F are schematic diagrams of exemplary port connection configurations (105a-105f). A 4-port network is fully characterized when information corresponding to 16 s-parameters (e.g., s₁₁, s₁₂, etc.) are obtained. An 8-port network is fully characterized when 64 s-parameters are obtained. For example, to fully characterize near end cross-talk, far-end cross-talk, and pass-through (i.e., unaffected by coupling), an 8×8 matrix of s-parameter measurements are obtained by combining 6-4×4 matrices of s-parameter measurements. The exemplary port connection configurations (105a-105f) enable the acquisition of all 64 s-parameters from six 4-port measurements to fully characterize the 8-port DUT 106. Sometimes, fewer measurements may be implemented in some embodiments to achieve acceptable accuracy in the model. Referring to FIG. 3A, a port connection configuration 105a is shown that includes the four ports 104 of the VNA 102 (FIG. 1A) and the DUT 106 shown with 8-ports (labeled port1-port8). Unused ports of the DUT 106 (e.g., port3, port4, port7, and port8) are terminated using, for example, a 50 Ω resistor (R) 112. FIGS. 3B-3F are not shown with the resistors 112 for clarity, although it will be understood that those DUT ports in configurations 105b-105f that are shown without a connection to the VNA ports 104 are terminated by the resistors 112.

In the set-up 105a shown in FIG. 3A, VNA port 1 and port 3 are connected to the DUT 106 at port2 and port1, respectively. VNA port 2 and 4 are connected at the DUT at port5 and port6, respectively.

Referring to the set-up 105b in FIG. 3B, VNA port 1 and port 3 are connected to the DUT 106 at port2 and port1, respectively. VNA port 2 and 4 are connected at the DUT at port3 and port4, respectively.

Referring to the set-up 105c in FIG. 3C, VNA port 1 and port 3 are connected to the DUT 106 at port2 and port1, respectively. VNA port 2 and 4 are connected at the DUT at port7 and port8, respectively.

Referring to the set-up 105d in FIG. 3D, VNA port 1 and port 3 are connected to the DUT 106 at port6 and port5, respectively. VNA port 2 and 4 are connected at the DUT at port7 and port8, respectively.

Referring to the set-up 105e in FIG. 3E, VNA port 1 and port 3 are connected to the DUT 106 at port4 and port3, respectively. VNA port 2 and 4 are connected at the DUT at port7 and port8, respectively.

Referring to the set-up 105f in FIG. 3F, VNA port 1 and port 3 are connected to the DUT 106 at port4 and port3, respectively. VNA port 2 and 4 are connected at the DUT at port5 and port6, respectively.

FIGS. 4A-4F are schematic diagrams that illustrate matrix processing as implemented by the method 110a shown in FIG. 2, the matrices generated based on the port configurations (105a-105f) shown in FIGS. 3A-3F. Referring to FIG. 4A, an 8×8 matrix 405a is shown corresponding to the s-parameter measurements taken with the configuration 105a (FIG. 3A). Each entry 401 in the matrix includes an s-parameter element. Although shown using numerals only (e.g., “13” in entry 401), it will be understood that each entry corresponds to an s-parameter entry, such as “s₁₃” for entry 401. In other words, “13” represents the s-parameter (s₁₃) measured when an input is provided at port3 of the DUT 106 and an output is measured at port1 of the DUT 106. Shaded areas 403 represent which s-parameters are covered or measured for the corresponding port connection configuration.

FIGS. 4B through 4F include matrices 405b-405f, which in turn correspond to s-parameter measurements taken using port connection configurations 105b-105f, respectively. For instance, matrix 405b corresponds to the s-parameter measurements taken using the port connection configuration 105b (FIG. 3B), and matrix 405c corresponds to the s-parameter measurements taken using the port connection configuration 105c (FIG. 3C), and so on.

A 4-port network is fully characterized when all 16 s-parameters (11-44) are measured, and an 8-port network is fully characterized when all 64 s-parameters (11-88) are measured. Thus, one goal is to cover (e.g., through measurement) all 64 s-parameters in an 8×8 matrix, such as shown in the matrix 405f in FIG. 4F, in which all s-parameters are covered (as represented by the shading). In one embodiment, this is achieved by taking six 4-port s-parameter measurements as explained above.

The above methodology to generate 8-port network models can be applied to generate network models that include information about cross-talk from different signal paths. Such models are generally referred hereinafter as victim/culprit coupling models. A victim generally refers to an intended signal path of a network or device. A culprit generally refers to a signal path that corrupts the victim, such as when high speed data wiring is bundled closely together. In one embodiment, a victim/culprit coupling model may be based on two or more frequency domain, 8-port differential cross-talk models to evaluate the cross-talk from different culprit pairs. Each of the 8-port models can be generated from the modeling method 110a using the same victim signal pairs but different culprits pairs (FIG. 2). Like the 8-port models described above, a victim/culprit coupling model can be used (by the simulation software 114) to characterize the electrical performance of high-speed links.

FIG. 5 is a flow diagram of a method embodiment 110b of the modeling software 110 (FIG. 1B), which provides for modeling cross-talk for multi-port networks. In one embodiment, a determination is made as to the number of culprit pairs, N (502). Depending on the topology of the network, data rates, and packaging (e.g., wiring proximity), there may be one or more culprit pairs. The modeling software 110 generates an 8-port model with one victim pair and one culprit pair (504). The 8-port generation occurs in a manner as described in the method 110a illustrated in FIG. 2. If there is more than one culprit pair (506), then an 8-port network model is generated with the victim pair as determined above and a second culprit pair (504). This process (504, 506, 508, 504, etc.) repeats itself for each culprit pair up to N. When 8-port models have been generated for N culprit pairs (including the victim pair in each model), the 8-port models (e.g., the data files corresponding to the s-parameter measurements) are combined to create a multi-port model (510).

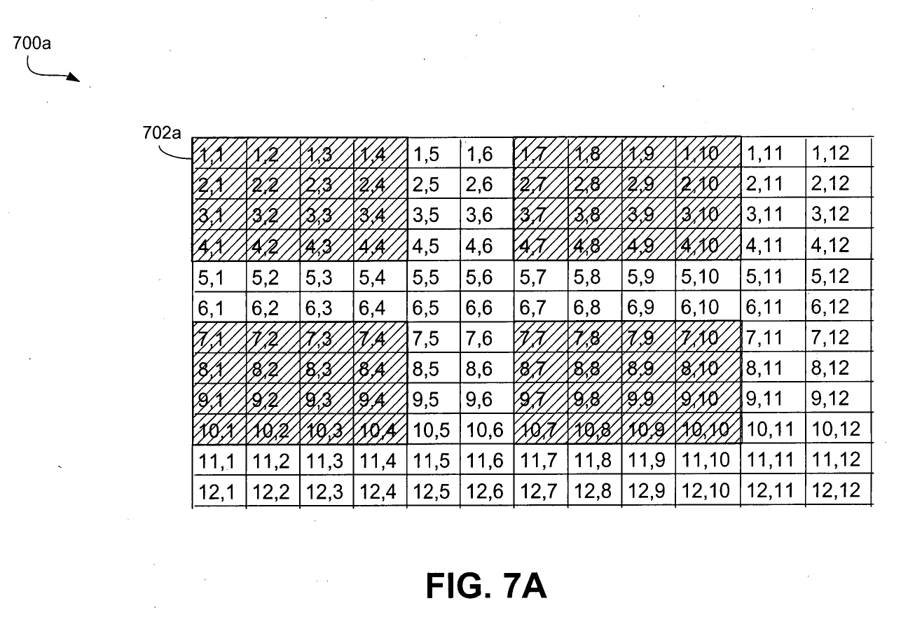

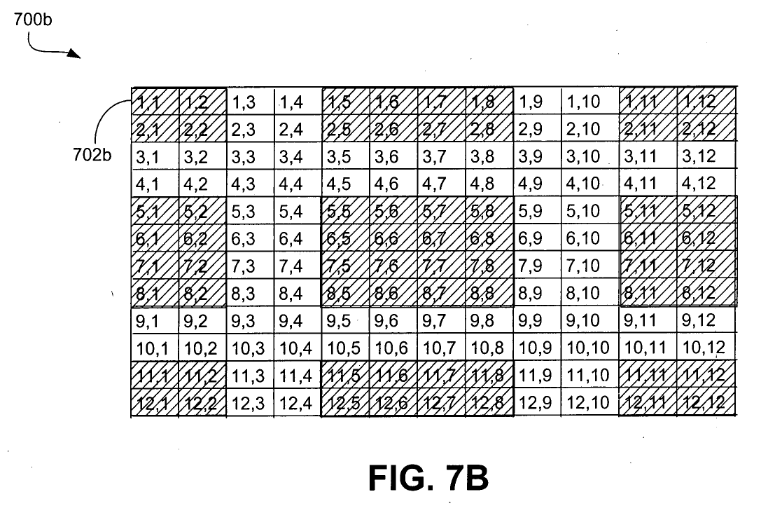

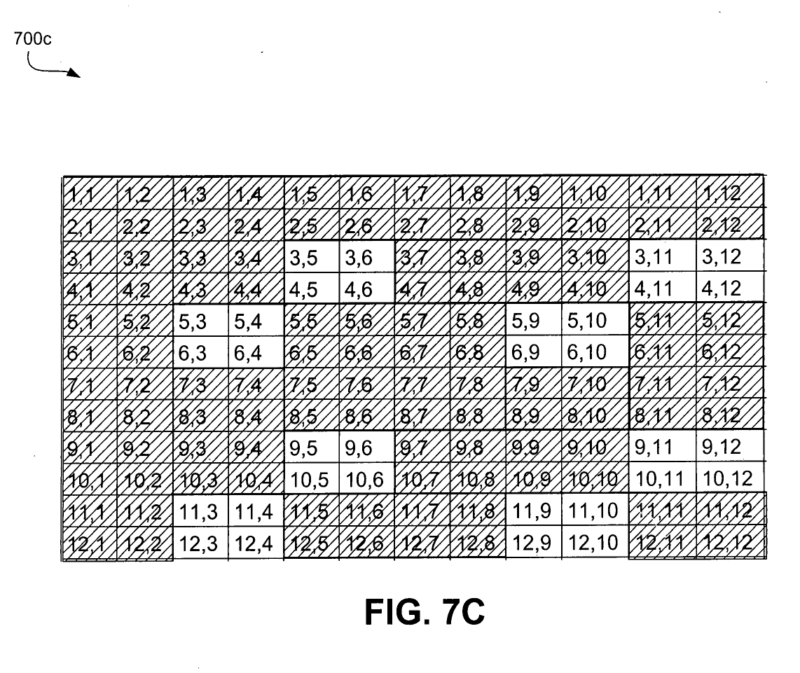

FIG. 6 is a schematic diagram that illustrates a 12-port DUT 606 with a victim pair 602 and two culprit pairs 603 and 604. Ports are designated port1 through port12. With continued reference to FIG. 6, FIGS. 7A-C are schematic diagrams of matrices 700a-700c, respectively, that illustrate matrix processing as implemented by the method 110b shown in FIG. 5. Regarding the matrix 700a of FIG. 7A, shaded portions, such as shaded portion 702a, represent s-parameter measurements from 8-port measurements between victim pair 602 (port1, port2, port7 and port8) and the first culprit pair 603 (port3, port4, port 9 and port10). These measurements provide information about the coupling that occurs to the victim pair due to the first culprit pair (i.e., culprit1). Regarding the matrix 700b of FIG. 7B, shaded portions (e.g., 702b) represent s-parameter measurements from 8-port measurements between victim pair 602 (port1, port2, port7 and port8) and the second culprit pair 604 (port5, port6, port11 and port12). The matrix 700c of FIG. 7C results from combining the matrices shown in FIGS. 7A and 7B. Note that some s-parameters (e.g., 3,5) have not been measured. S-parameter measurements not representing primary coupling effects (primary coupling effects corresponding to coupling effects between the victim pair and a culprit pair) may be ignored in some embodiments. The s-parameter 3,5, for example, do not represent a primary coupling effect since this parameter involves coupling between ports corresponding to culprit pairs (culprit pair1 and culprit pair2). In the embodiments described herein, primary coupling effects are of interest, and thus it has been determined that experimentally, it is of no significance for the purpose of adequately characterizing the 12-port DUT (606) to make measurements of these parameters. This determination of significance can also be performed in the context of a cost-benefits analysis. For example, although such measurements may be taken, in some instances, the benefits of taking all s-parameter measurements may be outweighed by the cost in time and money in performing the measurements and processing. In some embodiments, the engineer or designer may determine that he or she cannot ignore the effect of those un-measured terms.

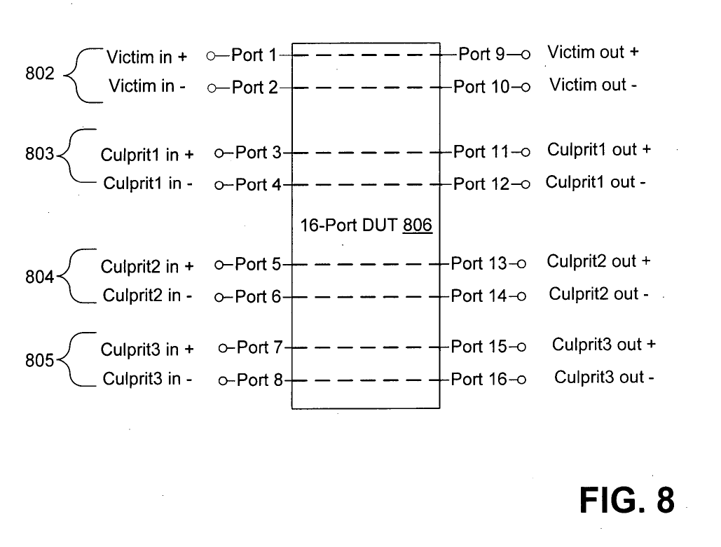

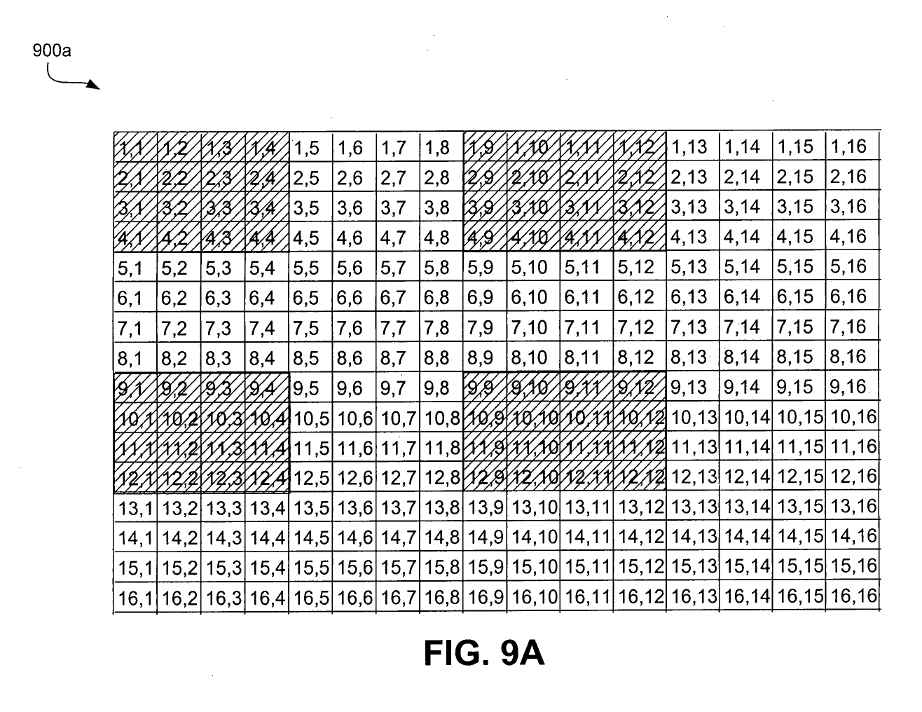

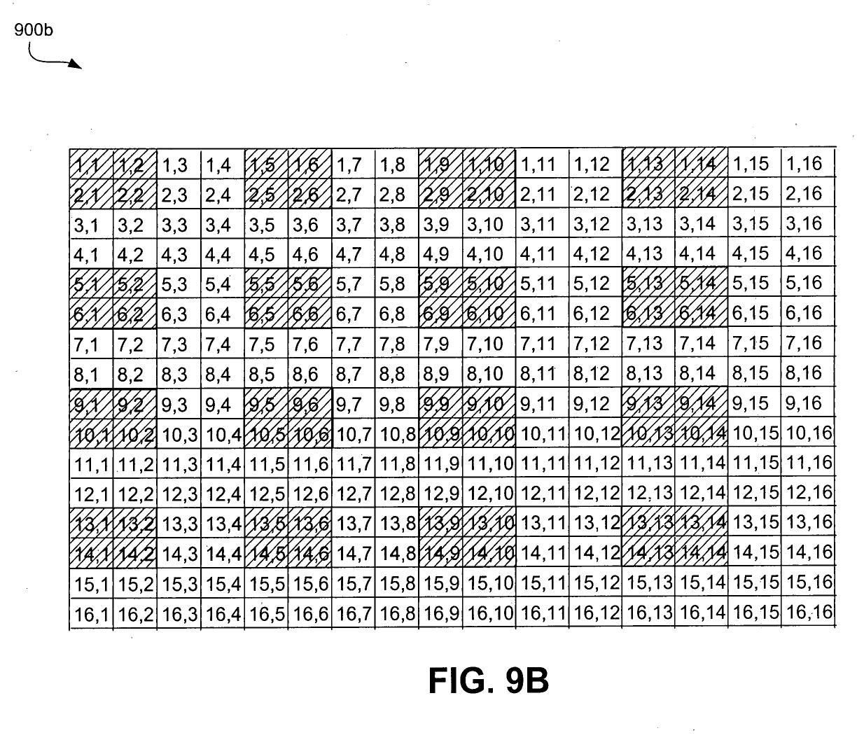

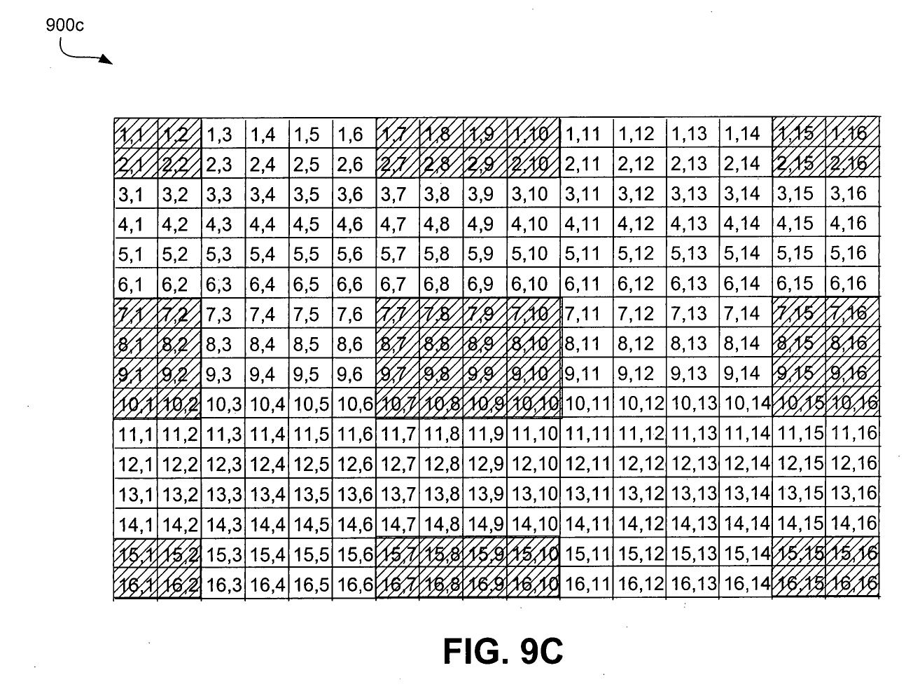

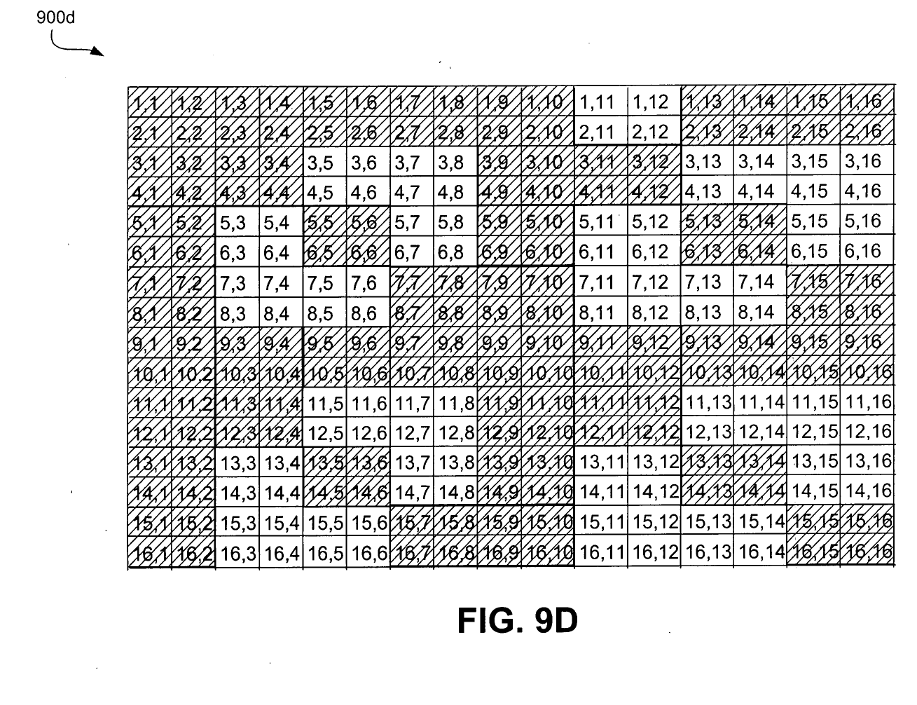

FIG. 8 is a schematic diagram that illustrates a 16-port DUT 806 with a victim pair 802 and three culprit pairs (803, 804, and 805). With continued reference to FIG. 8, FIGS. 9A-9D are schematic diagrams of matrices (900a-900d) that illustrate matrix processing as implemented by the method 110b (FIG. 5). Similar to the processing shown in FIGS. 7A-7C, 8-port s-parameter measurements are taken, with increasing coverage of the s-parameters as shown in matrices 900a-900c (FIGS. 9A-9C). These s-parameter measurements are combined in similar manner to that described above, resulting in the coverage shown in matrix 900d of FIG. 9D. Again, not all s-parameters are covered, but that is acceptable for this embodiment as experimentally confirmed.

What is claimed:

1. A network modeling method, comprising:
receiving six 4-port s-parameter measurements corresponding to an 8-port device;
saving the six 4-port s-parameter measurements in a plurality of data files; and
combining the plurality of data files into a model data file, the model data file representing the 8-port device.

2. The method of claim 1, further including acquiring the six 4-port s-parameter measurements from a measurement device having 4 ports from which the s-parameter measurements are taken.

3. The method of claim 2, wherein the measurement device includes a vector network analyzer.

4. The method of claim 1, wherein saving includes saving in a text file.

5. The method of claim 1, wherein combining includes executing a postscript operation on the plurality of data files.

6. The method of claim 1, wherein the model data file includes information corresponding to at least one of far end cross talk, near end cross talk, and pass through.

7. The method of claim 1, wherein the 8-port device includes a device under test.

8. The method of claim 7, wherein the device under test includes at least one of a network, a component, and a signal path.

9. The method of claim 1, further including providing the model data file to simulation software to be executed to characterize the performance of the 8-port device.

10. A network modeling system, comprising:
memory with modeling software; and
a processor configured with the modeling software to receive multiple 4-port s-parameter measurements corresponding to an 8-port device, save the multiple 4-port s-parameter measurements in a plurality of data files, and combine the plurality of data files into a model data file, the model data file representing the 8-port device.

11. The system of claim 10, wherein the processor is configured with the modeling software to receive six 4-port s-parameter measurements corresponding to an 8-port device and save the six 4-port s-parameter measurements in a plurality of data files.

12. The system of claim 10, further including a measurement device, wherein the measurement device includes 4 ports from which the s-parameter measurements are taken.

13. The system of claim 12, wherein the measurement device includes a vector network analyzer.

14. The system of claim 10, wherein the 8-port device includes a device under test, the device under test configured with at least one of a signal path to be measured and a component having predetermined performance features.

15. The system of claim 10, wherein the processor is configured with the modeling software to execute a postscript operation on the plurality of data files.

16. The system of claim 10, wherein the processor is configured with the modeling software to save the plurality of data files in respective text files.

17. The system of claim 10, wherein the model data file includes information corresponding to at least one of far end cross talk, near end cross talk, and pass through for the 8-port device.

18. The system of claim 10, wherein the modeling software is included in at least one of a computer and a vector network analyzer.

19. A network modeling system, comprising:
means for receiving six 4-port s-parameter measurements corresponding to an 8-port device;
means for saving the six 4-port s-parameter measurements in a plurality of data files; and
means for combining the plurality of data files into a model data file, the model data file representing the 8-port device.

20. The system of claim 19, wherein the means for receiving, saving, and combining includes software in memory, the software executed by a processor.

21. A computer program for modeling a network, the program being stored on a computer-readable medium, the computer-readable medium comprising:
logic configured to receive multiple 4-port s-parameter measurements corresponding to an 8-port device;
logic configured to save the multiple 4-port s-parameter measurements in a plurality of data files; and
logic configured to combine the plurality of data files into a model data file, the model data file representing the 8-port device.

22. A network modeling method, comprising:
generating a plurality of 8-port models, each of the plurality of 8-port models corresponding to a victim pair and a culprit pair for a multi-port device, the multi-port device having N ports; and
combining the plurality of 8-port models to generate an N-port model.

23. The method of claim 22, wherein generating a plurality of 8-port models includes generating a plurality of data files and combining the plurality of data files into a model data file, the model data file representing an 8-port device.

24. The method of claim 22, wherein combining includes combining a plurality of 8-port model data files.

25. The method of claim 22, further including determining a quantity of culprit pairs in the N-port model.

26. The method of claim 22, further including determining whether an 8-port model has been generated that includes the victim pair and every culprit pair.

27. A network modeling system, comprising:
a memory with modeling software; and
a processor configured with the modeling software to generate a plurality of 8-port models, each of the plurality of 8-port models corresponding to a victim pair and a culprit pair for an N-port device, wherein the processor is configured with the modeling software to combine the plurality of 8-port models to generate an N-port model.

28. The system of claim 27, wherein the processor is configured with the modeling software to generate a plurality of data files corresponding to s-parameter measurements of the N-port device and combine the plurality of data files into a model data file, the model data file representing an 8-port device.

29. The system of claim 27, wherein the processor is configured with the modeling software to combine a plurality of 8-port model data files.

30. The system of claim 27, wherein the processor is configured with the modeling software to determine a quantity of culprit pairs in the N-port model.

31. The system of claim 27, wherein the processor is configured with the modeling software to determine whether an 8-port model has been generated that includes the victim pair and every culprit pair.

32. The system of claim 27, wherein the modeling software is included in at least one of a computer and a vector network analyzer.

33. A network modeling system, comprising:
means for generating a plurality of 8-port models, each of the plurality of 8-port models corresponding to a victim pair and a culprit pair for a multi-port device, the multi-port device having N ports; and
means for combining the plurality of 8-port models to generate an N-port model.

34. The system of claim 33, wherein the means for generating and combining includes software in memory, the software executed by a processor.

35. A computer program for modeling a network, the program being stored on a computer-readable medium, the computer-readable medium comprising:
logic configured to generate a plurality of 8-port models, each of the plurality of 8-port models corresponding to a victim pair and a culprit pair for a multi-port device, the multi-port device having N ports; and
logic configured to combine the plurality of 8-port models to generate an N-port model.

36. A network modeling method, comprising:
receiving multiple 4-port s-parameter measurements corresponding to an 8-port device; and
generating an 8-port model from the multiple 4-port s-parameter measurements.
